(19) United States
(12) Patent Application Publication
(10) Pub. No.: US 2004/0161726 A1
(43) Pub. Date: Aug. 19, 2004

(54) Crown prosthesis

(75) Inventors: Sueo Saito, Tokyo (JP); Tetsuro Sakuma, Tokyo (JP); Futoshi Fusejima, Tokyo (JP); Toshihiro Sekiguchi, Tokyo (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: GC Corporation, Tokyo (JP)

(21) Appl. No.: 10/625,533

(22) Filed: Jul. 24, 2003

(30) Foreign Application Priority Data
Aug. 6, 2002 (JP) 2002-229109

(51) Int. Cl. A61C 5/08

(52) U.S. Cl. 433/222.1

(57) ABSTRACT

A crown prosthesis having a wear resistance and an aesthetic property that are equivalent to those of the conventional hard resin, and being able to be fixed inside the oral cavity in a short time to form a dental prosthesis, without necessity of careful formation of an abutment tooth under consideration of the shape and the structure of the dental prosthesis to be produced later. It also offers no necessity of indirect production of the dental prosthesis outside the oral cavity, the crown prosthesis comprising a polymer of a mixture of a polymerizable compound having an unsaturated double bond, a filler and a polymerization initiator, and having an outer shape resembling a tooth and a space to be filled with a dental composite resin between an inner surface thereof and an abutment tooth, preferably having a thickness of 0.1 to 2 mm, and having, in its inside space, a protrusion having a slot or a hole, for engaging or inserting a post implanted on a tooth root of a remaining tooth.

### BACKGROUND OF THE INVENTION

1. Field of the Invention

The present invention relates to a crown prosthesis having such wear resistance and aesthetic property that are equivalent to those of conventional hard resin, and being capable of forming a dental prosthesis fixed inside an oral cavity in a short period of time by connecting to an abutment tooth having been roughly formed through a dental composite resin.

2. Description of Conventional Art

In the case where a tooth suffers deficiency or a part of a tooth is lost, such a remedy has been widely practiced that an abutment tooth is formed, and a dental prosthesis resembling a tooth shape, which is called as a crown or a bridge, to be attached to the abutment tooth is produced outside an oral cavity, and then fixed to the abutment tooth by using a dental adhesive. At this time, in the case where an aesthetic property equivalent to a natural tooth is required, such a dental prosthesis is used as an acrylic-faced cast crown, a metal crown with porcelain facing, an acrylic-faced cast bridge, a metal bridge with porcelain facing and a full ceramic crown.

In the case where a dental prosthesis is fixed to a remaining tooth, and the remaining tooth has a substantially complete shape and can be used as an abutment tooth, a dentist necessarily machines the remaining tooth into a shape proximate to a circular conic form with a turbine before producing the dental prosthesis. Because a dental prosthesis is directly attached and fixed to an abutment tooth, the operation for forming the abutment tooth must be carefully carried out under consideration of the shape and the structure of the dental prosthesis to be produced later and thus requires a long period of time. Furthermore, in the case where a dental prosthesis is fixed to a remaining tooth, but only a tooth root of the remaining tooth remains, such an operation is necessary that a post formed with a metallic material or the like is fixed to a root canal, an abutment tooth is built-up on a side of an occlusal surface of the tooth root by using dental composite resin, followed by carefully machining the abutment tooth in the similar manner as in the foregoing.

Subsequently, an impression (a counter mold of the tooth) of a part including the abutment tooth is obtained from the oral cavity of the patient having been subjected to the operation for forming the abutment tooth. A plaster model (a duplicate of the tooth) is produced with the impression, and a dental prosthesis is produced based on the plaster model according to the following manner.

In the case of an acrylic-faced cast crown, an acrylic-faced cast bridge, a metal crown with porcelain facing and a metal bridge with porcelain facing a wax model of a core is produced on the plaster model with wax by a lost-wax process and then buried in a refractory investing material. After hardening the refractory investing material, the wax model is burnt out by heating in an electric furnace to obtain a casting mold. A metal is cast in the resulting casting mold to obtain a cast material, which is then dug out from the investing material and machined and ground to produce a metallic core. On the outer surface of the metallic core, a hard resin for dental crown is built-up and polymerized, or a ceramic material is built-up and baked, whereby the dental prosthesis is produced. In the case of a full ceramic crown, a duplicate model is produced by using a refractory model material, and a ceramic material is built-up and baked on the duplicate model. Thereafter, the refractory duplicate model is removed, and then the dental prosthesis is produced through trimming and polishing.

As having been described, the production of a dental prosthesis requires a prolonged period of time and skill because the operation therefor suffers complexity due to demand of significantly high accuracy in micrometer order and differences in shape of oral cavities and shapes of regions, in which the dental prosthesis is to be produced, among respective patients. In other words, the therapeutic period until the dental prosthesis is finally fixed inside the oral cavity of the patient is prolonged, and thus the patient suffers a large cost and a high burden. Furthermore, the operation is an indirect method, and therefore, substantially no case can be obtained where a dental prosthesis having perfect accuracy is produced even though it is produced by a skilled operator.

### SUMMARY OF THE INVENTION

An object of the present invention is to solve the problems associated with the conventional techniques and to provide a crown prosthesis having the following features in the case where a dental prosthesis is necessarily produced due to deficiency of a tooth or a part of a tooth is lost. The crown prosthesis has such a wear resistance and an aesthetic property that are equivalent to those of the conventional hard resin, and there is no necessity of careful formation of an abutment tooth under consideration of the shape and the structure of the dental prosthesis to be produced later. It also suffers no necessity of production of a plaster model through obtaining an impression or indirect production of the dental prosthesis outside the oral cavity, and the dental prosthesis can be fixed inside the oral cavity in a short period of time only inside a dental clinic.

As a result of earnest investigations made by the inventors in order to solve the problems, it has been found that, when an abutment tooth is roughly formed, instead of the conventional careful formation of an abutment tooth under consideration of the shape and the structure of the dental prosthesis to be produced later, and a crown prosthesis having an outer shape resembling a tooth and an inside space filled with a dental composite resin is pressed onto the abutment tooth, followed by hardening of the dental composite resin, to fix the crown prosthesis to the abutment tooth, a crown prosthesis so obtained has the features that there is no necessity of careful formation of an abutment tooth under consideration of the shape and the structure of the dental prosthesis to be produced later, and no necessity of production of a plaster model through obtaining an impression and indirect production of the dental prosthesis outside the oral cavity, and the dental prosthesis can be formed and fixed inside the oral cavity in a short period of time only inside a dental clinic. Thus the present invention has been accomplished.

Accordingly, the present invention relates to a crown prosthesis comprising a polymer of a mixture of a polymerizable compound having an unsaturated double bond, a filler and a polymerization initiator, and having an outer shape resembling a tooth and a space to be filled with a dental composite resin between an inner surface thereof and an abutment tooth. It is preferred that the crown prosthesis has a thickness of 0.1 to 2 mm. It is preferred that the crown prosthesis has, in the space, a protrusion having a hole or a slot, which a post implanted on a tooth root of a remaining tooth is penetrated into or engaged with.

### BRIEF DESCRIPTION OF THE DRAWINGS

FIG. 1 is a perspective view showing an example of a crown prosthesis for an anterior tooth according to the present invention viewed from the lingual side.

FIG. 2 is a centerline cross sectional view of FIG. 1.

FIG. 3 is a perspective view showing another example of a crown prosthesis for an anterior tooth according to the present invention viewed from the side of a tooth root.

FIG. 4 is a centerline cross sectional view showing an example of a crown prosthesis for a canine tooth according to the present invention.

FIG. 5 is a perspective view showing an example of a crown prosthesis for a molar tooth according to the present invention.

FIG. 6 is a centerline cross sectional view of FIG. 5.

FIG. 7 is a perspective view showing another example of a crown prosthesis for a molar tooth according to the present invention viewed from the side of a tooth root.

FIG. 8 is a side cross sectional view showing a state where the crown prosthesis shown in FIGS. 1 and 2 is attached to an abutment tooth formed with a remaining tooth through a composite resin.

FIG. 9 is a side cross sectional view showing a state where the crown prosthesis shown in FIG. 7 is attached to an abutment tooth build-up with a dental composite resin for core build-up on a tooth root of a remaining tooth through a dental composite resin.

### DESCRIPTION OF THE PREFERRED EMBODIMENTS

A crown prosthesis according to the present invention will be described in detail with reference to the drawings.

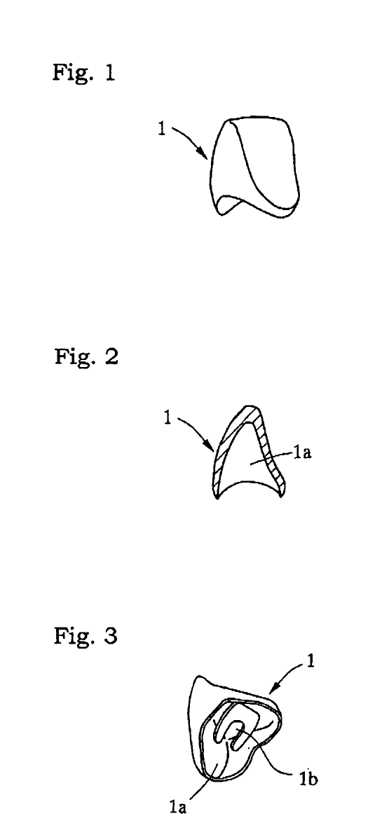

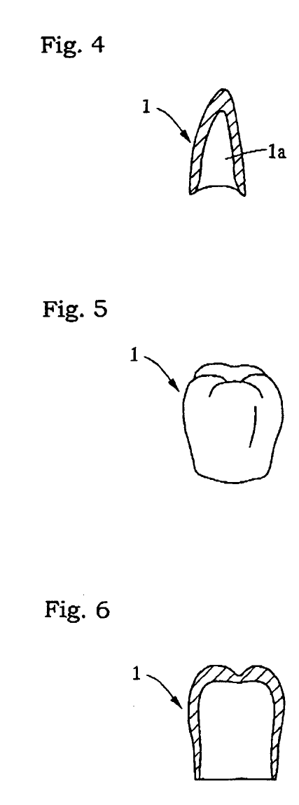

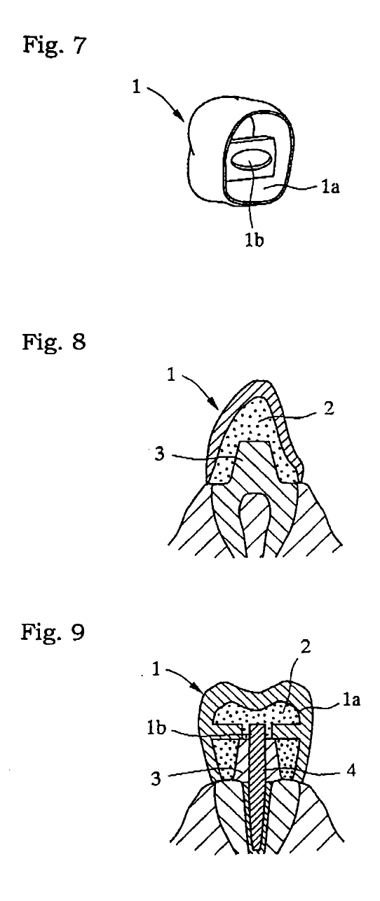

FIG. 1 is a perspective view showing an example of a crown prosthesis for an anterior tooth according to the present invention viewed from the lingual side, FIG. 2 is a centerline cross sectional view of FIG. 1, FIG. 3 is a perspective view showing another example of a crown prosthesis for an anterior tooth according to the present invention viewed from the side of a tooth root, FIG. 4 is a centerline cross sectional view showing an example of a crown prosthesis for a canine tooth according to the present invention, FIG. 5 is a perspective view showing an example of a crown prosthesis for a molar tooth according to the present invention, FIG. 6 is a centerline cross sectional view of FIG. 5, FIG. 7 is a perspective view showing another example of a crown prosthesis for a molar tooth according to the present invention viewed from the side of a tooth root, FIG. 8 is a side cross sectional view showing a state where the crown prosthesis shown in FIGS. 1 and 2 is attached to an abutment tooth formed with a remaining tooth through a composite resin, and FIG. 9 is a side cross sectional view showing a state where the crown prosthesis shown in FIG. 7 is attached to an abutment tooth build-up with a dental composite resin for core build-up on a tooth root of a remaining tooth through a dental composite resin.

In the figures, numeral 1 denotes a crown prosthesis according to the present invention, which contains a polymer of a mixture of a polymerizable compound having an unsaturated double bond, a filler and a polymerization initiator. The composition is the same as the conventional dental composite resin materials, which are referred to as hard resins, and therefore, the crown prosthesis has the characteristics owned by the conventional hard resin tooth, i.e., excellent wear resistance and excellent aesthetic property.

As the polymerizable compound having an unsaturated double bond used in the crown prosthesis 1 according to the present invention, a conventional polymerizable compound having an unsaturated double bond used for dental prostheses, such as hard resin, can be used, and in general, a monomer or an oligomer of methacrylate or acrylate having an unsaturated double bond is used. Specific examples of the polymerizable compound having an unsaturated double bond include methyl methacrylate, ethyl methacrylate, isopropyl methacrylate, 2-hydroxyethyl methacrylate, 3-hydroxypropyl methacrylate, 2-hydroxy-1,3-dimethacryloxypropane, n-butyl methacrylate, isobutyl methacrylate, butoxyethyl methacrylate, hydroxypropyl methacrylate, tetrahydrofurfuryl methacrylate, glycidyl methacrylate, 2-methoxyethyl methacrylate, 2-ethylhexyl methacrylate, benzyl methacrylate, ethylene glycol dimethacrylate, diethylene glycol dimethacrylate, triethylene glycol dimethacrylate, triethylene glycol trimethacrylate, butylene glycol dimethacrylate, neopentyl glycol dimethacrylate, 1,3-butanediol dimethacrylate, 1,4-butanediol dimethacrylate, 1,6-hexanediol dimethacrylate, trimethylolpropane trimethacrylate, trimethylolethane trimethacrylate, trimethylolmethane trimethacrylate, pentaerythritol trimethacrylate, pentaerythritol tetramethacrylate, polyoxytetraethylene glycol dimethacrylate, 2,2-bis(methacryloxyphenyl)propane, 2,2-bis(4-(2-hydroxy-3-methacryloxypropoxy)phenyl) propane, 2,2-bis(4-methacryloxydiethoxyphenyl)propane, 2,2-bis(4-methacryloxypolyethoxyphenyl)propane and an acrylate thereof, and a methacrylate having a urethane bond in the molecule, such as di-2-methacryloxyethyl-2,2,4-trimethylhexamethylene dicarbamate, 1,3,5-tris(1,3-bis(methacryloyloxy)-2-propoxy carbonylaminohexane)-1,3,5-(1H,3H,5H)triazin-2,4,6-trione, a urethane oligomer synthesized of 2,2′-di(4-hydroxycyclohexyl)propane, 2-oxepanone, hexamethylene diisocyanate and 2-hydroxyethyl methacrylate, and a urethane oligomer synthesized of 1,3-butanediol, hexamethylene diisocyanate and 2-hydroxyethyl methacrylate.

The mixing amount of the polymerizable compound having an unsaturated double bond in the crown prosthesis 1 according to the present invention is preferably 20 to 70% by weight based on the total weight while it varies depending on the filler used in combination. In the case where the mixing amount of the polymerizable compound having an unsaturated double bond is less than 20% by weight, there is such a tendency that the flexural strength is lowered, and in the case where it exceeds 70% by weight, there is such a tendency that the wear resistance is deteriorated.

The filler is mixed for imparting mechanical strength, such as wear resistance and breakage resistance, to the crown prosthesis 1 according to the present invention. Fillers used for the general hard resin can be used as the filler, and examples thereof include an inorganic filler containing powder of glass, such as silicon dioxide, barium glass, alumina glass, potassium glass and fluoroaluminosilicate glass, synthetic zeolite, calcium phosphate, feldspar, fumed silica, aluminum silicate, calcium silicate, magnesium carbonate and quartz. The inorganic filler may be subjected to a surface treatment with γ-methacryloxypropyltrimethoxysilane, vinyltrichlorosilane, vinyltriethoxysilane, vinyltrimethoxysilane, vinyltriacetoxysilane, vinyltri(methoxyethoxy)silane or the like. A so-called organic-inorganic composite filler, which is produced by the inorganic filler is mixed with a polymerizable monomer or oligomer and hardened, followed by pulverizing, and polymer powder can also be used.

The mixing amount of the filler is preferably from 25 to 75% by weight based on the total weight. In the case where the mixing amount of the filler is less than 25% by weight, there is such a tendency that the wear resistance of the crown prosthesis 1 according to the present invention is lowered, and in the case where it exceeds 75% by weight, there is such a tendency that the flexural strength is deteriorated.

As the polymerization initiator used in the crown prosthesis 1 according to the present invention, those for heat polymerization are mainly used, and for example, an organic peroxide and an azo compound are used. The organic peroxide is preferably a diacylperoxide having aromatic nature or a peroxyester that can be regarded as an ester of perbenzoic acid, and specific examples thereof include benzoyl peroxide, 2,4-dichlorobenzoyl peroxide, m-tolyl peroxide, t-butyl peroxybenzoate, di-t-butyl peroxyisophthalate, 2,5-dimethyl-2,5-di(benzoylperoxy)hexane and 2,5-dimethyl-2,5-di((o-benzoyl)benzoylperoxy)hexane, which can be effectively used. Examples of the azo compound include azobisisobutyronitrile, and in addition, an organic metal compound, such as tributylboron, can also be used.

The crown prosthesis 1 according to the present invention has a shape resembling an outer shape of an anterior tooth, a canine tooth or a molar tooth, and has a space 1a to be filled with a dental composite resin 2 between an inner surface thereof and an abutment tooth 3. The crown prosthesis 1 is to be attached to the abutment tooth 3 through the dental composite resin 2 thus filled, and preferably has a thickness of 0.1 to 2 mm. The thickness is determined under expectation of aesthetic property owing to accommodation with the color tone of the dental composite resin 2 thus filled between the crown prosthesis and the abutment tooth 3. In the case of a thickness of less than 0.1 mm, the strength of the prosthesis is insufficient, and in the case where it exceeds 2 mm, a color tone similar to a natural tooth can be hardly obtained, and adjustment of color becomes difficult upon utilizing the color tone of the dental composite resin 2 filled between the crown prosthesis and the abutment tooth 3.

A protrusion 1b having with a hole or a slot, which a post 4 implanted on a tooth root of a remaining tooth is penetrated into or engaged with, may be provided in the space la inside the crown prosthesis 1 according to the present invention. In the case where a protrusion 1b having a hole or a slot, which a post 4 implanted on a tooth root of a remaining tooth is penetrated into or engaged with, is provided in the space 1a inside the crown prosthesis 1, the workability when producing the dental prosthesis is improved, and also the strength of the dental prosthesis can be effectively ensured.

In the crown prosthesis 1 according to the present invention, in order to obtain an effect of the using method described later, it is preferred that the refractive index of the compound having an unsaturated double bond and the filler is adjusted, or the transparency is adjusted by mixing mainly titanium oxide as a turbidizing agent, whereby the crown prosthesis 1 is adjusted to be transparent or translucent, i.e., such color tone and transparency that are generally referred to as enamel in the field of dentistry. According to the configuration, the color tone of the dental composite resin 2 filled between the crown prosthesis and the abutment tooth 3 can be reflected on the prosthesis, and the color of the dental composite resin 2 can be adjusted as needed when filling it in the space 1a inside the crown prosthesis 1, whereby the color of the repaired tooth can be easily and accurately accommodated with the adjacent natural tooth. It is also possible that the crown prosthesis 1 according to the present invention contains a coloring agent that is contained in the conventional hard resin.

In the method for using the crown prosthesis 1 according to the present invention, there is no necessity of careful formation of an abutment tooth, under consideration of the shape and the structure of the dental prosthesis to be produced later, and there is no necessity of indirect operations, such as formation of an impression, production of a plaster model, and production of a dental prosthesis outside an oral cavity, but a dental prosthesis is formed only by a direct operation carried out inside an oral cavity, i.e., an abutment tooth 3 is roughly formed, and a crown prosthesis 1 is filled with a dental composite resin 2 in an inside space 1a and then overlaid and fixed on the abutment tooth 3.

Specifically, in the case where the prosthesis is fixed to a remaining tooth, and only a tooth root of the tooth remains, a dental prosthesis fixed inside an oral cavity is formed only by an operation carried out inside an oral cavity in the following manner. A root canal having been subjected to root canal preparation is filled with a dental adhesive or a dental composite resin, such as a dental composite resin for core build-up, and a post 4 is implanted therein. In the case where the root canal is filled with the dental composite resin, the dental composite resin is polymerized depending on necessity, and a part 3 corresponding to the conventional abutment tooth is built-up by using a dental composite resin for core build-up. After building-up the abutment tooth 3 through polymerization depending on necessity, the crown prosthesis 1 according to the present invention is filled with a dental composite resin 2 in an inside space 1a and then overlaid and fixed on the abutment tooth 3.

In the case where the prosthesis is fixed to a remaining tooth, and the remaining tooth has a substantially complete shape, a dental prosthesis fixed inside an oral cavity is formed only by a direct operation carried out inside an oral cavity in the following manner. The remaining tooth is machined into an abutment tooth 3 having a rough shape with a turbine, and the abutment tooth 3 is subjected to a surface treatment or a primer treatment with an acid, such as citric acid and phosphoric acid. The crown prosthesis 1 according to the present invention is then filled with a dental composite resin 2 in an inside space 1a and then overlaid and fixed on the abutment tooth 3.

In the foregoing operations, upon overlaying the crown prosthesis 1 according to the present invention having the dental composite resin 2 filled in the inside space 1a on the abutment tooth 3, the dental composite resin 2 running over the crown prosthesis 1 according to the present invention on the side of gingiva is necessarily wiped out before the dental composite resin 2 being polymerized and hardened.

### EXAMPLES

The present invention will be described in more detail with reference to the examples below.

### Example 1

10.0% by weight of triethylene glycol dimethacrylate and 19.0% by weight of di-2-methacryloxyethyl-2,2,4-trimethylhexamethylene dicarbamate as the compounds having an unsaturated double bond, 1% by weight of azobisisobutyronitrile as the polymerization initiator, and 21.2% by weight of an organic-inorganic composite filler, 45.7% by weight of glass powder having an average particle diameter of 5 μm and 3.1% by weight of colloidal silica having an average particle diameter of 0.04 μm as the fillers were mixed, and a pigment in an amount within a range of 0.6 part by weight or less was added and mixed with 100 part by weight of the mixture to adjust the transparency and the color, so as to obtain a mixture in a uniform paste form. The mixture was pressed at 90° C. for 60 minutes in a metallic mold for forming an artificial tooth that provides a desired space inside, so as to produce a crown prosthesis of a enamel color for a molar tooth having a thickness of 0.2 to 0.7 mm and a shape resembling an outer shape of a molar tooth.

The organic-inorganic composite filler used in Example 1 and Example 2 described later was a colloidal silica organic-inorganic composite filler having an average particle diameter of 19 μm produced in the following manner. Azobisisobutyronitrile as a polymerization catalyst was added in an amount of 1% by weight to a mixture obtained by mixing di-2-methacryloxyethyl-2,2,4-trimethylhexamethylene dicarbamate and triethylene glycol dimethacrylate at a weight ratio of 3/7 to form a mixed solution, and 70% by weight of the mixed solution and 30% by weight of colloidal silica having an average particle diameter of 0.04 μm were mixed and hardened by heating at 95° C., followed by pulverization.

A repairing method will be described for the case where the crown prosthesis for a molar tooth of Example 1 is fixed to a remaining tooth, and only a tooth root of the tooth remains.

A tooth to be remedied was subjected to root canal preparation according to an ordinary method to form a post hole. The post hole was treated with a dental primer (Unifil Core Self-etching Bond, a trade name, produced by GC Corp.) and filled with a dental composite resin for core build-up (Unifil Core Composite Paste, a trade name, produced by GC Corp.), and a post (D.T. LIGHT-POST, a trade name, produced by RTD Corp.) was inserted therein. A gap between the tooth and the post was filled with the dental composite resin for core build-up, and then the dental composite resin (Unifil Core) was polymerized to implant the post. Subsequently, a rough abutment tooth was build-up around the post protruding from the root canal as a core by using the dental composite resin (Unifil Core) and the dental composite resin (Unifil Core) was polymerized. Thereafter, a dental composite resin (various colors of Unifil Flow, a trade name, produced by GC Corp.) having the substantially same composition as the dental composite resin for core build-up and a color tone accommodated with a natural tooth was prepared, and the dental composite resin (Unifil Flow) was filled in a space inside the crown prosthesis. The crown prosthesis was overlaid on the abutment tooth, and the dental composite resin (Unifil Flow) running over the crown prosthesis on the side of gingiva was wiped out. The dental composite resin (Unifil Flow) was then polymerized and hardened to attach the crown prosthesis to the abutment tooth through the dental composite resin (Unifil Flow) to form a dental prosthesis for a molar tooth.

### Example 2

7.1% by weight of trimethylolpropane trimethacrylate and 21.8% by weight of di-2-methacryloxyethyl-2,2,4-trimethylhexamethylene dicarbamate as the compounds having an unsaturated double bond, 1% by weight of azobisisobutyronitrile as the polymerization initiator, and 16.2% by weight of an organic-inorganic composite filler, 45.7% by weight of glass powder having an average particle diameter of 5 μm and 8.2% by weight of colloidal silica having an average particle diameter of 0.04 μm as the fillers were mixed, and a pigment in an amount within a range of 0.6 part by weight or less was added and mixed with 100 part by weight of the mixture to adjust the transparency and the color, so as to obtain a mixture in a uniform paste form. The mixture was pressed at 95° C. for 60 minutes in a metallic mold for forming an artificial tooth that provides a desired space inside, so as to produce a crown prosthesis of a enamel color for an anterior tooth having a thickness of 0.3 to 0.9 mm and a shape resembling an outer shape of an anterior tooth.

A repairing method will be described for the case where the crown prosthesis for an anterior tooth of Example 2 is fixed to a remaining tooth, and the remaining tooth has a substantially complete shape.

A remaining tooth to be remedied was machined into a rough shape with a turbine, and the surface of the abutment tooth was treated with an acid, such as citric acid and phosphoric acid. Thereafter, a dental composite resin (various colors of Unifil Flow, a trade name, produced by GC Corp.) having the substantially same composition as the dental composite resin for core build-up and a color tone accommodated with a natural tooth was prepared, and the dental composite resin was filled in a space inside the crown prosthesis. The crown prosthesis was overlaid on the abutment tooth, and the dental composite resin running over the crown prosthesis on the side of gingiva was wiped out. The dental composite resin was then polymerized and hardened to attach the crown prosthesis to the abutment tooth through the dental composite resin to a dental prosthesis for an anterior tooth.

As described in detail in the foregoing, the crown prosthesis according to the present invention is for producing a dental prosthesis in such a manner that an abutment tooth is roughly formed, and a crown prosthesis having an inside space filled with a dental composite resin is overlaid on the abutment tooth, followed by polymerizing and hardening of the dental composite resin, to fix the crown prosthesis to the abutment tooth through the dental composite resin. Therefore, there is no necessity of careful formation of an abutment tooth under consideration of the shape and the structure of the dental prosthesis to be produced later, no necessity of formation of an impression or production of a plaster model, or no necessity of production of a dental prosthesis based on complicated operations in a dental laboratory, and dental remedy with accurate color tone can be easily carried out in a short period of time with a one-time treatment inside a dental clinic. Consequently, the crown prosthesis exerts significant value through contribution to dental remedy.

What is claimed is:

1. A crown prosthesis comprising a polymer of a mixture of a polymerizable compound having an unsaturated double bond, a filler and a polymerization initiator, and having an outer shape resembling a tooth and a space to be filled with a dental composite resin between an inner surface thereof and an abutment tooth.

2. A crown prosthesis as claimed in claim 1, wherein the crown prosthesis has a thickness of 0.1 to 2 mm.

3. A crown prosthesis as claimed in claim 1 or 2, wherein the crown prosthesis has, in the space, a protrusion having a hole or a slot, which a post implanted on a tooth root of a remaining tooth is penetrated into or engaged with.
